(19) United States
(12) Patent Application Publication
(10) Pub. No.: US 2019/0080179 A1
(43) Pub. Date: Mar. 14, 2019

(54) MONITORING SYSTEM AND TERMINAL DEVICE

(71) Applicant: HITACHI KOKUSAI ELECTRIC INC., TOKYO (JP)

(72) Inventor: RYOSUKE KIMURA, TOKYO (JP)

(21) Appl. No.: 16/084,335

(22) PCT Filed: Mar. 8, 2017
(86) PCT No.: PCT/JP2017/009249

§ 371 Date: Sep. 12, 2018

(30) Foreign Application Priority Data
Mar. 29, 2016 (JP) 2016-065705

(51) Int. Cl. G06K 9/00; H04N 7/18; H04N 5/247; G06K 9/46

(52) U.S. Cl. CPC G06K 9/00778; H04N 7/181; G06T 2207/30232; G06K 9/46; H04N 5/247

(57) ABSTRACT

A monitoring system includes an imaging device and a terminal device. The terminal device includes a 3D processing unit that converts a planar area map to 3D. The terminal device displays a coordinate association screen wherein image data captured by the imaging device and the area map that has been converted to 3D by the 3D processing unit are superposed, and displays, on the planar area map, a rectangular region and a measurement point specified from the coordinate association screen.

### FIELD OF THE INVENTION

The present invention relates to a monitoring system and a terminal device.

### BACKGROUND OF THE INVENTION

Conventionally, a video monitoring system is installed in facilities, e.g., large-scale commercial facilities, event halls, airports, stations, roads and the like, where unspecified people visit in order to prevent accidents and the like. The video monitoring system captures an image of a person to be monitored or the like by using an imaging device such as a camera or the like, transmits the image to a monitoring center such as a management office, a security office or the like so that a monitoring person who works therein can monitor the image and respond thereto, if necessary.

Under these circumstances, the video monitoring system having various functions for reducing labor of a monitoring person is spreading. In particular, recently, there is suggested a video monitoring system having a more advanced search function, such as a function of automatically detecting occurrence of a specific event in a video in real time or the like, by using a video processing technique.

The video monitoring system can be realized by pinpointing a congestion status of each camera installation area on an electronic guide map in large-scale commercial facilities, for example. The result thereof is used for assigning a large number of security guards in a high congestion area, for example.

As a prior art document, Patent Document 1 discloses therein, e.g., an image processing apparatus for detecting a suspicious object by comparing a brightness of an image captured by a two-dimensional imaging device with a brightness of a reference image which is closest thereto and setting off an alarm.

Patent Document 1: Japanese Patent Application Publication No. 2011-61651

Patent Document 2: Japanese Patent Application Publication No. 2011-124658

Patent Document 3: Japanese Patent Application Publication No. 2015-32133

### SUMMARY OF THE INVENTION

Along with development and accuracy improvement of an image processing technology and dramatic evolution of a camera resolution, it is possible to operate multivalued and various image processing information by one camera, and it is required to accurately and simply associate a plurality of measurement points/rectangles within an angle of view of one camera with a plurality of measurement points/rectangles on an area map. However, in order to link a point on the camera image which is spatial information to a point on the area map which is planar information, it is required to observe a screen with naked eyes or perform accurate measurement in an actual field. The former is inaccurate, and the latter requires efforts.

The object of the present invention is to improve monitoring efficiency by simply linking an area map to a camera image.

In accordance with an aspect of the present invention, there is provided a monitoring system including: an imaging device; and a terminal device, wherein the terminal device includes a 3D processing unit configured to convert a planar area map to 3D, the terminal device displaying a coordinate association screen where image data captured by the imaging device and the area map that has been converted to 3D by the 3D processing unit are superposed, and displaying, on the planar area map, a rectangular region and a measurement point specified from the coordinate association screen.

The monitoring system further includes a control device configured to calculate a degree of congestion at the measurement point, wherein the control device transmits a control request based on the degree of congestion to the imaging device.

In accordance with another aspect of the present invention, there is provided a terminal device including: an image reception unit configured to receive an image data; a 3D processing unit configured to convert a planar area map to 3D; and a display unit, wherein the display unit displays a coordinate association screen where the image data captured by the image reception unit and the area map that has been converted to 3D by the 3D processing unit are superposed, and displays on the planar area map a rectangular region and a measurement point specified from the coordinate association screen.

### Effect of the Invention

In accordance with the present invention, it is possible to improve monitoring efficiency by simply linking an area map to a camera image.

### BRIEF DESCRIPTION OF THE DRAWINGS

FIG. 1 is a block diagram showing a configuration of a monitoring system according to an embodiment of the present invention.

FIG. 2 is a flowchart for explaining an operation of the monitoring system according to the embodiment of the present invention.

FIG. 3 is a flowchart for explaining an operation of a terminal device according to an embodiment of the present invention.

FIG. 4 explains a coordinate association screen of the terminal device according to the embodiment of the present invention.

FIG. 5 explains an area map adjustment unit and a 3D processing unit of the terminal device according to the embodiment of the present invention.

FIG. 6 shows a coordinate association screen for explaining application of a measurement point and a rectangle of the terminal device according to the embodiment of the present invention.

FIGS. 7A to 7C explain drawing of a measurement point and a rectangle of the terminal device according to the embodiment of the present invention on a planar region.

FIGS. 8A and 8B explain geometry calculation concept of coordinate association between a camera image of the terminal device according to the embodiment of the present invention and an area map.

FIG. 9 explains control of an imaging device using the terminal device according to the embodiment of the present invention.

### DETAILED DESCRIPTION OF THE EMBODIMENTS

Hereinafter, embodiments will be described with reference to the accompanying drawings.

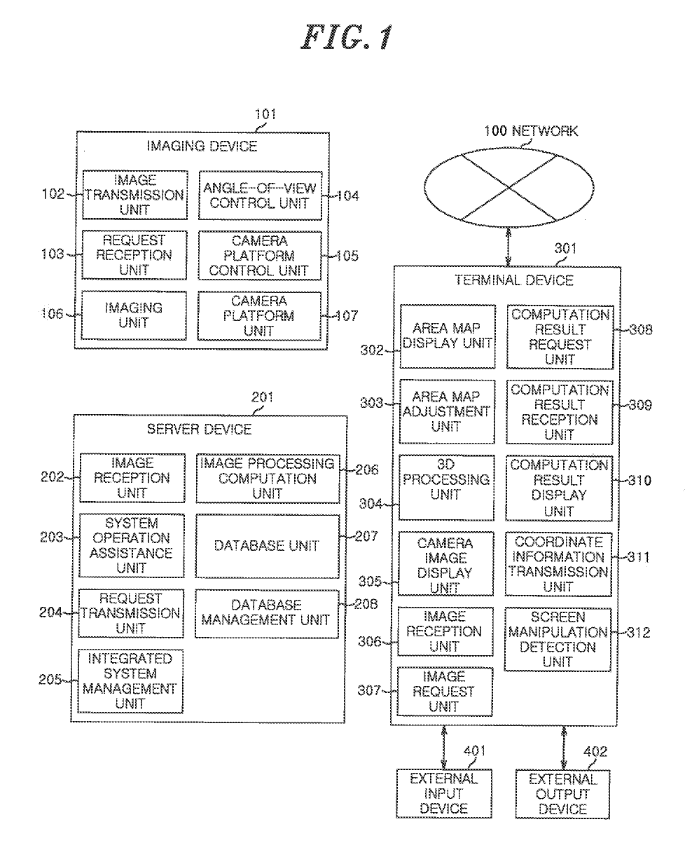

FIG. 1 is a block diagram showing a configuration of a monitoring system according to an embodiment.

Referring to FIG. 1, the monitoring system includes an imaging device 101, a server device 201, a terminal device 301, and a network 100.

The network 100 serves as a dedicated network for performing data communication or a communication device such as Intranet, Internet, a wireless LAN (Local Area Network) or the like. The network 100 connects the imaging device 101, the server device 201, the terminal device 301 and the like.

The imaging device 101 includes an image transmission unit 102, a request reception unit 103, an angle-of-view control unit 104, a camera platform control unit 105, an imaging unit 106, and a camera platform unit 107.

The imaging unit 106 images a subject by using a CCD (Charge Coupled Device), a CMOS (Complementary Metal Oxide Semiconductor) device or the like, performs digital processing on the captured image, and outputs the processed image via the network 100.

The server device 201 and the terminal device 301 may be a PC (Personal Computer) having a network function. In this configuration, the server device 201 and the terminal device 301 are configured in a load-distributed manner. However, the server device 201 and the terminal device 301 may be configured as one unit.

The image transmission unit 102 is a processing unit for outputting image data captured by the imaging unit 106 to the server device 201, the terminal device 301 and the like via the network 100.

The request reception unit 103 is a processing unit for receiving a request command from the server device 201, the terminal device 301, and the like via the network 100, decodes request command contents, and transmits the decoded contents to each unit in the imaging device.

The angle-of-view control unit 104 controls an angle of view (zoom magnification) of a lens unit (not shown) in response to the request contents received by the request reception unit 103.

The camera platform control unit 105 controls the camera platform unit 107 based on the request contents received by the request reception unit 103.

The camera platform unit 107 performs pan and tilt operations based on the control information of the camera platform control unit 105.

The server device 201 includes an image reception unit 202, a system operation assistance unit 203, a request transmission unit 204, an integrated system management unit 205, an image processing computation unit 206, a database unit 207, and a database management unit 208.

The image reception unit 202 is a processing unit for inputting an image from the imaging device 101 and the terminal device 301 via the network 100.

The system operation assistance unit 203 creates instruction contents to be transmitted to the imaging device 101.

The request transmission unit 204 transmits the instruction contents created by the system operation assistance unit 203 to the imaging device 101.

The integrated system management unit 205 manages the setting elements of the entire monitoring system, such as the network configuration, various process settings and the like.

The image processing computation unit 206 performs specific image processing computation on a received image. For example, the image processing computation unit 206 estimates a degree of congestion at main points within an angle of view.

The database unit 207 stores the image data, the image processing computation result, position information, time information and the like that are associated with each other. The database unit 207 also stores information on an area map, and setting coordinates and an IP address of each camera.

The database management unit 208 manages input/output of data between the database unit 207 and the terminal device 301.

The terminal device 301 includes an area map display unit 302, an area map adjustment unit 303, a 3D (Three Dimensions) processing unit 304, a camera image display unit 305, an image reception unit 306, an image request unit 307, a computation result request unit 308, a computation result reception unit 309, a computation result display unit 310, a coordinate information transmission unit 311, and a screen manipulation detection unit 312.

The area map display unit 302 displays the area map read out from the database unit 207 on a GUI (Graphical User Interface) application.

The area map adjustment unit 303 performs enlargement, reduction, rotation, and excision of the area map.

The 3D processing unit 304 performs three-dimensional display of the area map expressed on a 2D plane, adjustment of yaw, pitch and roll, and the like.

The camera image display unit 305 displays the image data received by the image reception unit 306 on the GUI application.

The image reception unit 306 is a processing unit for inputting an image from the imaging device 101, the server device 201 or the like via the network 100.

The image request unit 307 is a processing unit for requesting an image output. In this example, the image request unit 307 requests the imaging device 101 to output image data.

The computation result request unit 308 requests the database management unit 208 while specifying certain conditions (place, time and the like) via the network 100 to output a computation result (e.g., degree of congestion).

The computation result reception unit 309 receives from the database unit 207 the computation result in response to the request from the computation result request unit 308.

The computation result display unit 310 displays the computation result received by the computation result reception unit 309 on the GUI application.

The coordinate information transmission unit 311 transmits coordinate point fitting information between the area map and the camera image to the server device 201.

The screen manipulation detection unit 312 receives a manipulation from an external input device 401.

The external input device 401 includes a keyboard, a pointing device (mouse), and the like.

The external output device 402 is a display device or the like.

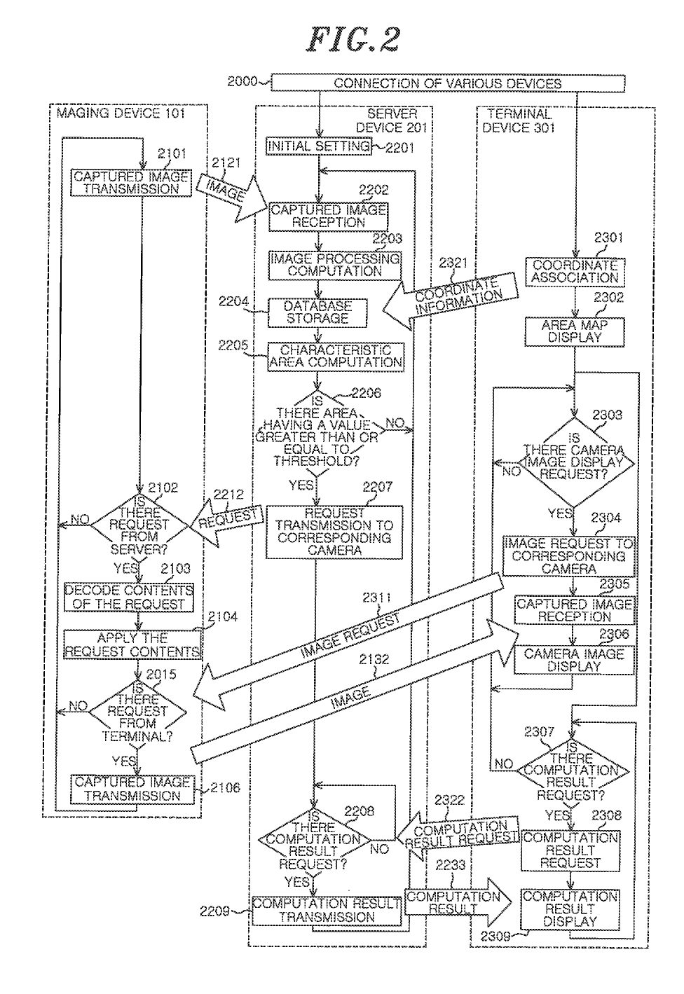

Next, the operation of the monitoring system will be described with reference to FIG. 2.

FIG. 2 is a flowchart for explaining the operation of the monitoring system according to the embodiment.

Before the operation is started, various devices are connected (2000).

As for initial setting, the server device 201 sets a network configuration, various process settings and the like in the integrated system management unit 205 (2201).

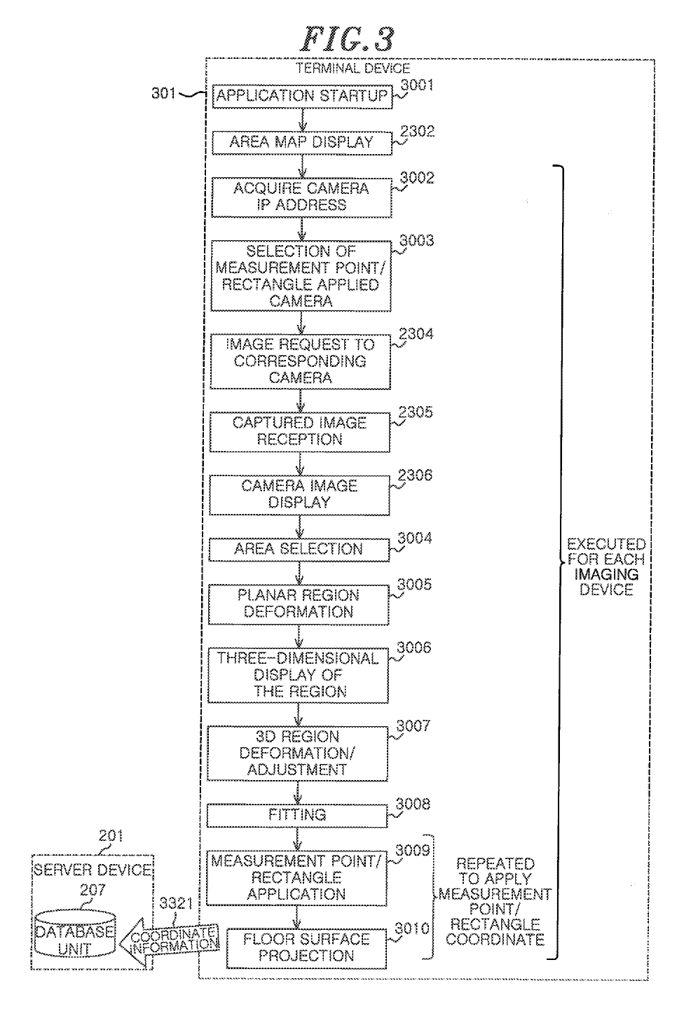

As for the preparation of the terminal device 301, coordinates of a measurement point and a rectangle between the camera image and the area map are associated (2301). The coordinate association will be described later with reference to FIGS. 3 to 6. Here, the camera position and the measurement point/rectangle on the area map are set.

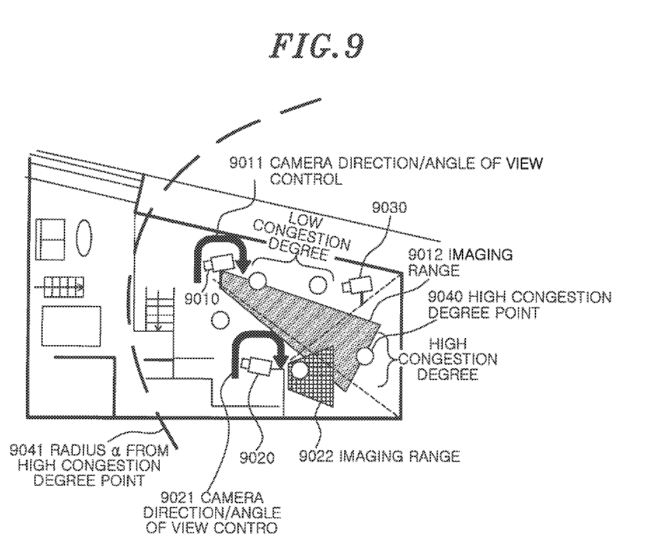

Next, the actual operation will be described with reference to FIGS. 2 and 9.

FIG. 9 explains imaging device control using an area map of a terminal device according to an embodiment.

Referring to FIG. 2, the imaging device 101 transmits image data 2121 captured by the imaging unit 106 from the image transmission unit 102 to the image reception unit 202 of the server device 201 via the network 100 (2101).

The image reception unit 202 of the server device 201 receives the image data 2121 captured by the imaging unit 106 (2202).

The image processing computation unit 206 performs predetermined image processing computation on the image data 2121 received by the image reception unit 202 (2203), and outputs the computation result to the database unit 207.

The database unit 207 stores the computation result in association with the image data 2121 (2204).

The server device 201 accumulates (stores) XY coordinates in area, measurement time T and image processing computation value V, which are associated with each other, by repeating these processes.

The system operation assistance unit 203 performs an operation on a characteristic area by using database information of the database unit 207 (2205). This operation is performed to find an area where the image processing computation value has predetermined characteristics. For example, when the image processing computation value is a congestion degree point, a higher congestion degree point indicates a higher congestion area.

The system operation assistance unit 203 obtains information on a point where an average image processing computation value v1 in a range backward from current time by unit time t is greater than or equal to a threshold value vt by using a measurement point and a rectangle within a unit circle about a point x1y1 (2206).

When the image processing computation value is a degree of congestion and a high congestion area is found, in order to monitor the point of the high congestion area from wider angles, the system operation assistance unit 203 transmits a request 2212 for directing photographing directions of cameras 9010 and 9020 installed within a radius a 9041 of a high congestion degree point (9040) shown in FIG. 9 toward the corresponding point 9040 from the request transmission unit 204 to the request reception unit 103 of the imaging device 101 via the network 100 (2207).

Specifically, the system operation assistance unit 203 reads out a yaw-pitch-roll angle and pan-tilt information of the cameras 9010 and 9020, the coordinates of the congestion degree point 9040, and the coordinates of the cameras 9010 and 9020 from the database unit 207, calculates a difference between the read-out information and a yaw-pitch-roll angle and pan-tilt information that is appropriate for the cameras 9010 and 9020 to capture an image the congestion point 9040 from the spatial relation between the congestion degree point coordinates and the camera coordinates, and transmits the yaw-pitch-roll-angle and the pan-tilt information to the cameras 9010 and 9020. It is not necessary to control the imaging device 101 from the server device 201, and the imaging device 101 may be controlled from another control device having the functions of the system operation assistance unit 203 and the request transmission unit 204.

The request reception unit 103 of the imaging device 101 determines whether or not the request (2212) has been transmitted from the server device 201 (2102). When the request has been transmitted (YES), the processing proceeds to the step 2103. When no request has been transmitted (NO), the processing returns to the step 2101.

The request reception unit 103 decodes the contents of the request 2212 (2103) and the processing proceeds to the step 2104.

In order to apply the request contents (2104), the request reception unit 103 transmits angle-of-view information to the angle-of-view control unit 104 based on the decoded contents and transmits photographing direction information to the camera platform control unit 105. The angle-of-view control unit 104 controls a lens unit (not shown) based on the angle-of-view information, and the camera platform control unit 105 controls the camera platform unit 107 based on the photographing direction information.

Referring to FIG. 9, the system operation assistance unit 203 calculating a high congestion degree area in real time and transmits the request 2212 based on the result to a corresponding camera (imaging device) in real time. Accordingly, the congestion point can be automatically tracked.

In a monitoring system for detection of a specific person (see, e.g., Patent Document 2) and a specific object (see, e.g., Patent Document 3), as the number of persons, objects and behaviors within the angle of view are increased probabilistically, the chance of setting off alarm indicating discovery of a specific person, object and behavior is increased. In this way, the monitoring system can be used for a more efficient operation of the image processing detection/search system than a camera having a fixed angle of view.

Next, the actual operation between the server device 201 and the terminal device 301 will be described.

Referring to FIG. 2, the terminal device 301 allows the area map display unit 302 to display an area map on the installed GUI application (2302).

It is assumed that camera installation coordinates are previously registered on the area map.

Further, it is assumed that the information on the correlation between the camera installation coordinates and the camera IP address is stored in the database unit 207 of the server device 201.

When the screen manipulation detection unit 312 of the terminal device 301 detects that the camera coordinate point on the area map is pressed by mouse clock, it is determined that there is a camera image display request (2303).

The computation result request unit 308 requests the database management unit 208 of the server device 201 to output the IP (Internet Protocol) address of the camera which corresponds to the camera coordinate point detected by the screen manipulation detection unit 312. The database management unit 208 reads out the IP address stored in the database unit 207 and transmits the IP address to the computation result reception unit 309 of the terminal device 301.

The camera image request unit 307 transmits an image request 2311 to the imaging device 101 having the IP address received by the computation result reception unit 309 via the network 100(2304).

The request reception unit 103 of the imaging device 101 which has received the image request 2311 determines that there is the image request 2311 from the terminal device 301 (2105), and then transmits the image data captured by the imaging device 106 to the image transmission unit 102.

The image transmission unit 102 transmits the image data 2132 captured by the imaging unit 106 to the image reception unit 306 of the terminal device 301 via the network 100 (2106).

The image reception unit 306 of the terminal device 301 receives the image data 2132 (2305) and transmits the image data 2132 to the camera image display unit 305.

The camera image display unit 305 displays the image data 2132 (2306). By repeating these processes, a continuous image (moving image) is obtained.

The area map display unit 302 can perform superposition display of the image processing computation result obtained by the image processing computation unit 206 of the server device 201 on the area map. To that end, the computation result request unit 308 requests the database management unit 208 of the server device 201 to output a computation result while specifying specific conditions (place and time) (2308).

The database management unit 208 determines that there is the computation result request 2322 when receiving the computation result request 2322 from the computation result request unit 306 of the terminal device 301 (YES), and reads out the computation result 2233 from the database unit 207 and transmits it to the computation result reception unit 309 of the terminal device 301 (the computation result transmission (2209)).

When the computation result reception unit 309 receives the computation result 2233, the terminal device 301 allows the computation result display unit 310 to perform superposition display of the computation result on the area map (computation result display (2309)).

Next, the association between the measurement point and the rectangle between the camera image and the area map will be described with reference to FIGS. 3 to 7.

FIG. 3 is a flowchart for explaining the operation of the terminal device according to the embodiment of the present invention.

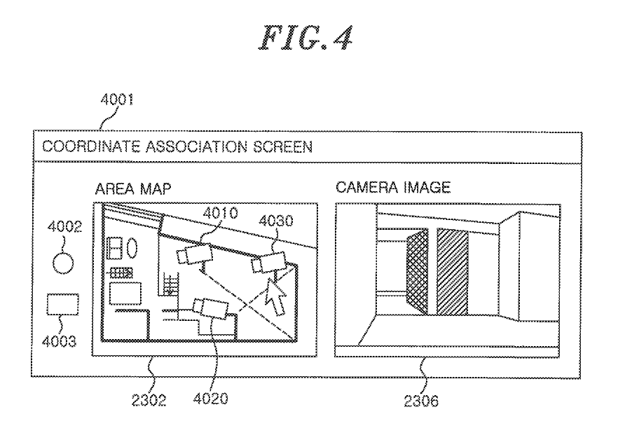

FIG. 4 explains the coordinate association screen of the terminal device according to the embodiment of the present invention.

Referring to FIG. 3, the terminal device 301 activates the installed GUI application (3001) and displays the area map 2302 on a coordinate association screen 4001 shown in FIG. 4 by using the function of the area display unit 302.

The area map 2302 is formed of line segments. The height information is associated with the line segments and coordinates in the map.

Referring to FIG. 4, the terminal device 301 superimposes a camera icon 4020 on the camera coordinate point of the area map 2302 and acquires the camera IP address (3002) by mouse clicking the camera icon 4020.

After the camera IP address is acquired, the terminal device 301 associates the measurement point and the rectangle within the angle of view of the camera with the area map.

In the terminal device 301, when the associated camera in the area map 2302 is selected (selection of measurement point/rectangle applied camera) (3003)), the computation result request unit 308 requests the database management unit 208 of the server device 201 to output the IP address of the camera which corresponds to the camera coordinate point detected by the screen manipulation detection unit 312 in order to display the camera image on the camera image display unit 305. The database management unit 208 reads out the IP address stored in the database unit 207 and transmits the IP address to the computation result reception unit 309 of the terminal device 301.

The camera image request unit 307 transmits the image request 2311 to the imaging device 101 of the IP address received by the computation result reception unit 309 via the network 100 (2304).

The request reception unit 103 of the imaging device 101 which has received the image request 2311 determines that there is the image request 2311 from the terminal device 301 (2105), and then transmits the image data captured by the imaging unit 106 to the image transmission unit 102.

The image transmission unit 102 transmits the image data 2132 captured by the imaging unit 106 to the image reception unit 306 of the terminal device 301 via the network 100 (2106).

The image reception unit 306 of the terminal device 301 receives the image data 2132 (2305) and transmits the image data 2132 to the camera image display unit 305.

The camera image display unit 305 displays the image data 2132 (still frame at the time of request) (2306).

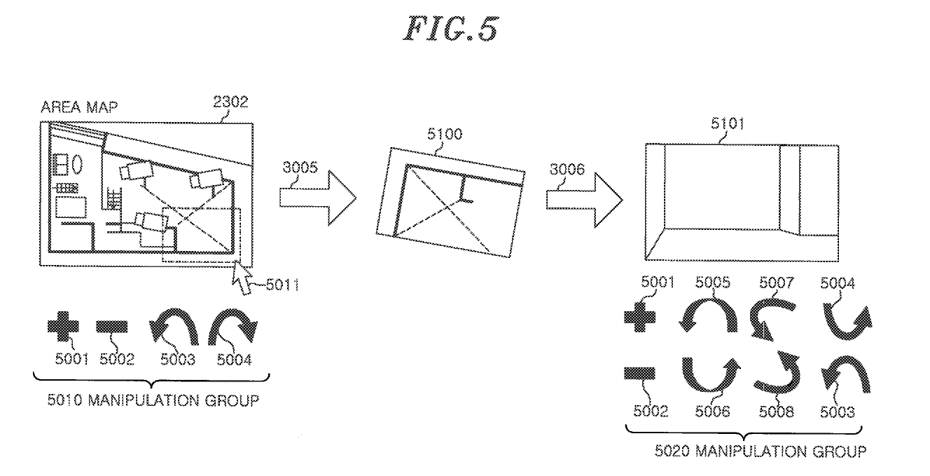

Next, the operation of the area map adjustment unit and the 3D processing unit of the terminal device according to the embodiment of the present invention will be described with reference to FIGS. 3 and 5.

FIG. 5 explains the area map adjustment unit and the 3D processing unit of the terminal device according to the embodiment of the present invention.

When an area 5011 on the area map 2302 shown in FIG. 5 is selected (3004), the terminal device 301 allows the area map adjustment unit 303 to perform enlargement, reduction, rotation, and excision of the area map on a planar region 5100 by using a mouse or the like (planar region deformation (3005)).

Next, the 3D processing unit 304 performs three-dimensional display of the region (3006) and its adjustment (3D region deformation/adjustment (3007)) in order to three-dimensionally display the area map 5100 expressed on a 2D plane.

The 3D processing unit 304 performs fitting (3008) for making a 3D area map 5101 close to the camera image by manipulating, e.g., a pan-tilt and yaw-pitch-roll adjustment buttons (manipulation group) 5020.

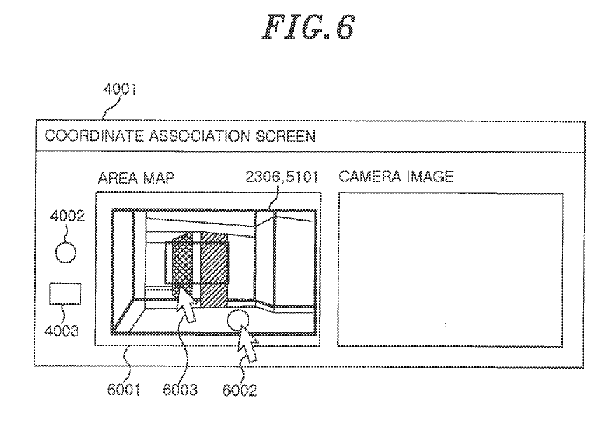

Next, application of the measurement point and the rectangle of the terminal device according to the embodiment of the present invention will be described with reference to FIGS. 3 and 6.

FIG. 6 shows a coordinate association screen for explaining the application of the measurement point and the rectangle of the terminal device according to the embodiment of the present invention.

Referring to FIG. 6, the terminal device 301 floats a camera image 6001 on a 3D area map in a specific section of the three-dimensional region, displays the camera image 6001 semi-transparently, and performs fitting 3008. After the fitting is completed, the measurement point and the rectangle on the camera image are drawn on the area map (measurement point/rectangle application (3009)). Accordingly, the drawing result is projected onto the planar area map by geometry calculation (floor surface projection (3010)).

For example, in order to draw the measurement point and the rectangle, the terminal device 301 prepares a measurement point icon 4002 and a measurement rectangle icon 4003 on the coordinate association screen 4001. When the measurement point icon 4002 is clicked with a mouse and then clicked again on the area map, the measurement point 6002 is determined. When the measurement rectangle icon 4003 is clicked with a mouse and, then, the closed rectangle is drawn on the area map (6003), the measurement rectangle is determined.

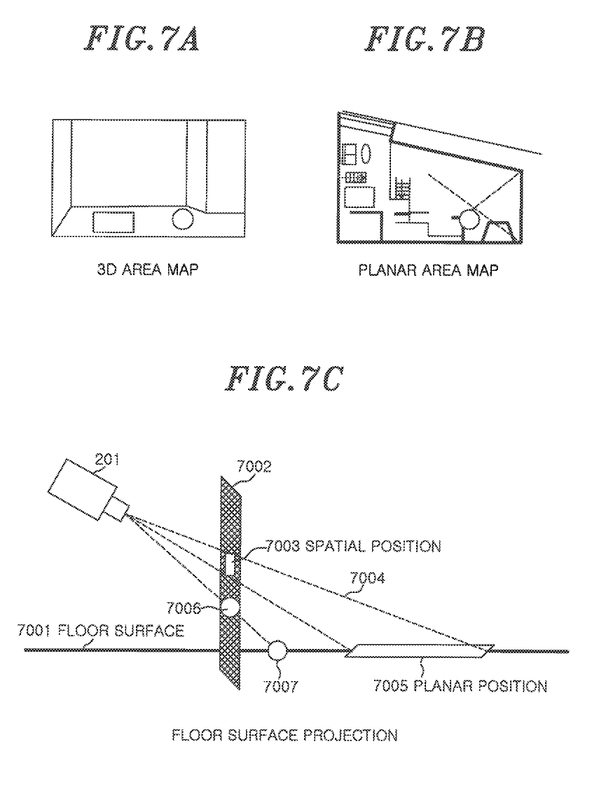

Next, the drawing (floor surface projection) of the measurement point and the rectangle of the terminal device according to the embodiment of the present invention on the planar area will be described with reference to FIGS. 7A to 7C.

FIGS. 7A to 7C explain the drawing of the measurement point and the rectangle of the terminal device according to the embodiment of the present invention on the planar area.

Referring to FIGS. 7A to 7C, when the point and the rectangle drawn on the 3D area map (FIG. 7A) are drawn on a vertical plane 7002 at a camera focal distance, the terminal device 301 projects on the planar area map each point 7007 that crosses with the floor when a line 7004 connecting the lens center of the camera 201 and each point is extended to the floor surface. Although a camera depth direction is imaged in FIGS. 7A to 7C, the same operation is performed in a right-left direction.

After the coordinate information is determined, the terminal device 301 transmits the coordinate information 2321 from the coordinate information transmission unit 311 to the server device 201.

The database unit 207 of the server device 201 stores the received coordinate information 2321.

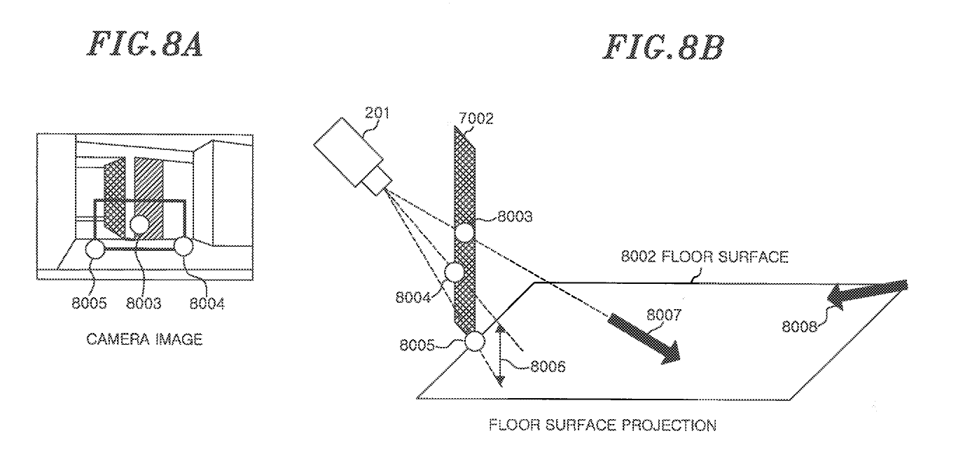

Next, the geometry calculation concept of the coordinate association between the camera image and the area map of the terminal device according to the embodiment of the invention will be described with reference to FIGS. 8A and 8B.

FIGS. 8A and 8B explain the geometry calculation concept of coordinate association between the camera image and the area map of the terminal device according to the embodiment of the present invention.

Referring to FIGS. 8A and 8B, at the time of fitting, the terminal device 301 performs automatic geometry calculation of a yaw-pitch-roll angle with respect to an area map reference vector angle 8008 from a perpendicular vector angle 8007 extending perpendicularly from the lens center of the camera 201 and performs automatic geometry calculation of the degree of pan-tilt from a distance between floor surface points 8006 corresponding to a lower left point and a lower right point of the lens, and then transmits the calculation result to the database unit 207 of the server device 201.

The database unit 207 of the server device 201 stores the received pan/tilt degree.

The monitoring system according to the embodiment of the present invention includes the imaging device and the terminal device, and is characterized in that the terminal device includes a 3D processing unit that converts a planar area map to 3D, the terminal device displaying a coordinate association screen wherein image data captured by the imaging device and the area map that has been converted to 3D by the 3D processing unit are superposed, and displaying, on the planar area map, a rectangular region and a measurement point specified from the coordinate association screen. Accordingly, it is possible to improve monitoring efficiency by linking an area map to a camera image in a simple manner.

While one embodiment of the present invention has been described in detail, the present invention is not limited thereto and various modifications can be made without departing from the spirit of the present invention.

For example, the area map information may be stored in the terminal device, not in the server device.

The present invention can be applied to the case of improving monitoring efficiency by easily associating the area map with the camera image.

### DESCRIPTION OF REFERENCE NUMERALS

100 network
101 imaging device
102 image transmission unit
103 request reception unit
104 angle of view control unit
105 camera platform control unit
106 imaging unit
107 camera platform unit
201 server device
202 image reception unit
203 system operation assistance unit
204 request transmission unit
205 integrated system management unit
206 image processing computation unit
207 database unit
208 database management unit
301 terminal device
302 area map display unit
303 area map adjustment unit
304 3D processing unit
305 camera image display unit
306 image reception unit
307 image request unit
308 computation result request unit
309 computation result reception unit
310 computation result display unit
311 coordinate information transmission unit
312 screen manipulation detection unit
401 external input device unit
402 external output device unit

What is claimed is:

1. A monitoring system comprising:
an imaging device; and
a terminal device,
wherein the terminal device includes a 3D processing unit configured to convert a planar area map to 3D, the terminal device displaying a coordinate association screen where image data captured by the imaging device and the area map that has been converted to 3D by the 3D processing unit are superposed, and displaying, on the planar area map, a rectangular region and a measurement point specified from the coordinate association screen.

2. The monitoring system of claim 1, further comprising:
a control device configured to calculate a degree of congestion at the measurement point,
wherein the control device transmits a control request based on the degree of congestion to the imaging device.

3. A terminal device comprising:
an image reception unit configured to receive an image data;
a 3D processing unit configured to convert a planar area map to 3D; and
a display unit,
wherein the display unit displays a coordinate association screen where the image data captured by the image reception unit and the area map that has been converted to 3D by the 3D processing unit are superposed, and displays on the planar area map a rectangular region and a measurement point specified from the coordinate association screen.
